(19) United States
(12) Patent Application Publication
(10) Pub. No.: US 2009/0018201 A1
(43) Pub. Date: Jan. 15, 2009

(54) Method of Combating Bugs

(75) Inventors: Kenichi Kojima, Aichi-Prefecture (JP); Antonio Zarco-Montero, Sevilla (ES); Akihide Watanabe, Kanagawa (JP); Gerhard Walther, Sevilla (ES); Samuel Wells, Gary, NC (US); Nigel Armes, Raleigh, NC (US); Robert A. Farlow, Carrboro, NC (US); Hassan Oloumi-Sadeghi, Raleigh, NC (US)

Correspondence Address: BRINKS, HOFER, GILSON & LIONE, 2801 SLATER ROAD, SUITE 120, MORRISVILLE, NC, 27560, US

(73) Assignee: BASF Aktiengesellschaft, Ludwigshafen (DE)

(21) Appl. No.: 11/916,236

(22) PCT Filed: May 30, 2006
(86) PCT No.: PCT/EP06/62717

§ 371 Date: Nov. 30, 2007

Related U.S. Application Data
(60) Provisional application No. 60/687,023, filed on Jun. 3, 2005.

(51) Int. Cl. A01N 37/52; A01P 7/04

(52) U.S. Cl. 514/614; 514/632

(57) ABSTRACT

A method of combating bugs comprising contacting the bugs or their food supply, habitat, breeding grounds or their locus with a pesticidally effective amount of a compound of the formula (I) wherein W is Cl or CF₃; X and Y are each independently Cl or Br; R¹ is alkyl, alkenyl, alkynyl, or cycloalkyl optionally substituted with 1 to 3 halogens, or alkyl which is substituted by alkoxy; R² and R³ are alkyl or may be taken together to form cycloalkyl optionally substituted by 1 to 3 halogens; R⁴ is H or C₁-C₆-alkyl, or the enantiomers or salts thereof.

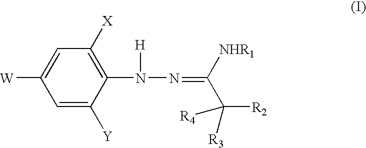

The present invention relates to a method of combating bugs comprising contacting the bugs or their food supply, habitat, breeding grounds or their locus with a pesticidally effective amount of a compound of formula I

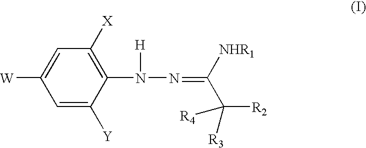

wherein
W is chlorine or trifluoromethyl;
X and Y are each independently chlorine or bromine;
R¹ is C₁-C₆-alkyl, C₃-C₆-alkenyl, C₃-C₆-alkynyl, or C₃-C₆-cycloalkyl which may be substituted with 1 to 3 halogen atoms, or C₂-C₄-alkyl which is substituted by C₁-C₄-alkoxy;
R² and R³ are C₁-C₆-alkyl or may be taken together to form C₃-C₆-cycloalkyl which may be unsubstituted or substituted by 1 to 3 halogen atoms;
R⁴ is hydrogen or C₁-C₆-alkyl,
   or the enantiomers or salts thereof.

The present invention also relates to the use of compounds of formula I and of compositions comprising them for combating bugs.

Bugs are agricultural pests that damage crops with their piercing/sucking mouthparts by injecting digestive enzymes into the crop which helps liquify plant tissues for easy extraction by the bug and by feeding on the plant juices or the (developing) seeds. Nymphs as well as adults feed on plants. Bugs are among the most damaging insect pests in agriculture. The losses associated with crop damage caused by bugs represent a significant problem in numerous crops including fruits, vegetables and other plants.

The abundance of agricultural bugs has increased in the last years. This is partly due to a number of changes in the agricultural environment that have made crop hosts available year-round, including widespread adoption of conservation tillage, crop rotation and conservation and wetland reserve programs. In addition, the practical eradication of some agricultural pests such as the boll weevil in cotton in the U.S.A. and the use of insect resistant crops have both resulted in less use of broad-spectrum insecticides which has turned pests once considered secondary, such as bugs, into significant insect problems.

Besides, traditional insecticides employed for bug control such as malathion, methyl parathion or carbaryl exhibit unfavorable toxicological and environmental properties and may cause damage of the crops which are treated for bugs.

It was therefore an object of the present invention to provide new methods for combating bugs.

We have found that this object is achieved by the present invention.

In earlier application PCT/EP/04/013687 the use of compounds of formula I against some non-crop true bugs has been described the control of which is not subject of the present invention.

Compounds of formula I which can be used according to the invention are known from and can be prepared according to preparation methods described or referenced in EP-A 604 798. This document discloses the insecticidal and acaricidal activity of compounds of formula I and other compounds against pests of the Coleoptera, Lepidoptera and Acarina orders. No mention is made of the use of compounds I against bugs.

Adult bugs mate in the spring and females lay eggs on plants. The hatched nymphs will go through a number of stages to mature into adults, the overall progress from egg to the adult state occurring in less than three months. Thus, depending on the species, bugs annually have 1 to 3 generations. This life cycle goes along with population increases. A close monitoring for the number of pests, can thus be favourable to detect the best point in time for use of the insecticide. Agricultural bugs hibernate in protected, warm areas and thus enter buildings.

The compounds of formula I and compositions comprising them are suitable for systemic and/or non-systemic control of bugs. They are active against nymphs and adults.

The present invention is especially useful for combating bugs of the list:

Acrosternum hilare, Anasa armigera, A. tristis, Atarsocoris brachiariae, Blissus antillus, B. insularis, B. leucopterus, B. occidus, Boisea rubronlineata, B. trivittata, Campylomma verbasei, Chelinidea spp., Chlorochroa ligata, C. sayi, C. uhleri, Cimex hemipterus, C. lectularis, Corecoris dentiventris, Corythuca angulata, C. aruata, C. celtides, C. cycloniae, C. juglandis, C. marmorata, C. pallipes, C. ulmi, Cyrtomenus mirabis, Cyrtopeltis notatus, Diactor bilineatus, Diaphnocoris chlorionis, Dichelops furcatus, Dysdercus cingulatus, D. intermedius, Edessa meditabunda, Eurydema festivum, E. ornatum, E. ventralis, Euschistus conspersus, E. heros, E. impictiventris, E. servus, E variolarius, Euthochtha galeator, Gargaphia solani, G. tilla, Halticotoma valida, Halticus bracteatus, Jadera haematoloma, Leptoglossus clypealls, L. corculus, L. gonagra, L. occidentalis, L. phyllopus, L. stigma, Lopidia confluenta, L. davisi, Lybindus dichrous, Lygaeus angustomarginatus, L. kalmll, Lygus Hesperus, L. ilneolaris, L. pratensis, Murgantia histrionica, Neomegalotomus parvus, Nezara viridula, Niesthra louisianica, Nilaparvata lugens, Nysius angustatus, N. niger, N. raphanus, Oebalus poecilus, Pachylis pharaonis, Piesma quadrats, Piezodorus guildinii, Plagiognathus albatus, Platytylus bicolor, Poecilocapsus lineatus, Psylla mali, P. piri, Phthia picta, Reduvius senilis, Scaptocoris castanea, Solubea insularis, Stepahanitis pyrioides, S. rhododendri, S takeyai, Teleonemia scrupulosa, Tenthecoris orchidearum, Thyanta accerra, T custator, T pallidovirens, T perditor, Tibraca limbativentris, Triatoma spp., Trichopoda nitens, and Tropidosteptes amoenus.

Also, the inventive method is especially useful for combating bugs of the following families: Coreidae, Lygaeidae, Nabidae, Miridae, Pentatomidae, Pyrrhocoridae, Rhopalidae, Scutelleridae, and Tingidae.

Furthermore, the inventive method is especially useful for combating bugs selected from the group of Anasa armigera, A. tristis, Edessa meditabunda, Eurydema festivum, E. ornatum, E. ventralis, Euschistus conspersus, E. heros, E. impictiventris, E. servus, E. variolarius, Euthochtha galeator, Lygus Hesperus, L. lineolaris, L. pratensis, Murgantia histrionica, Nezara viridula, Thyanta accerra, T custator, T pallidovirens, T Perditor, Trigonotylus coelestialum (Rice leaf bug), Stenotus rubroviftatus (Sorghum plant bug), Paromius exiguous, Nezara antennata (Common green stink bug), Lygus Hesperus (Western plant bug), Leptocorisa corbetti (Leaf-footed bug), Lagynotomus elongates (Brown rice stink bug), Halticus bracteatus (Garden fleahopper), Euschistus spp (Stink bug spp.), Eurydema ornatum (Cabbage bug), Cletus trigonus (Slender rice bug).

The inventive method is especially useful for control of bugs in

broad-leaf weeds, soybean, snap bean, maize, sorghum, sunflower, cotton, colza, cereals like barley, oats, rye, wheat, rice, and corn,
vegetables like beans (snap, pole, and Lima), cabbage, cantaloupe, cucumber, leafy greens, okra, onions, pepper, peas, squash, sweet corn, potato, eggplant, tomato, lettuce, leek, garlic, onion, carrot, sugar beet, or (water)melon, cauliflower, broccoli, pumpkins, gourds, turnip and radish,
fruits like citrus fruits such as lemon, mandarin, or orange, stone fruits, mulberries, grapes, apricot, cherry, peach, pear, pome fruits, fig, kurrajong, and strawberry,
ornamental plants like wisteria, dahlia, violet, geranium and petunia, but also in buildings.

Moreover, the present mixtures can preferably be employed for combating pests on rice, cotton, vegetables, soybean, and fruits.

Very preferably, the inventive method is used against stink bugs in soybeans and vegetables (including cole crops).

Also, very preferably, the inventive method is used against stink bugs (including but not limited to sorghum plant bug, rice leaf bug, brown rice stink bug and slender rice bug) in rice.

With respect to their intended use according to the present invention, preference is further given to compounds of formula I wherein

W is trifluoromethyl;
X and Y are each independently chlorine or bromine;
R¹ is C₁-C₆-alkyl;
R² and R³ are C₁-C₆-alkyl or may be taken together to form C₃-C₆-cycloalkyl which is substituted by 1 to 2 halogen atoms;
R⁴ is C₁-C₆-alkyl; or the enantiomers or salts thereof.

Particular preference is given to N-ethyl-2,2-dimethylpropionamide-2-(2,6-dichloro-α,α,α-trifluoro-p-tolyl)hydrazone and N-Ethyl-2,2-dichloro-1-methylcyclopropane-carboxamide, 2-(2,6-dichloro-α,α,α-trifluoro-p-tolyl)hydrazone.

Particular preference is given to N-ethyl-2,2-dimethylpropionamide-2-(2,6-dichloro-α,α,α-trifluoro-p-tolyl)hydrazone.

Also, particular preference is given to N-Ethyl-2,2-dichloro-1-methylcyclopropane-carboxamide, 2-(2,6-dichloro-α,α,α-trifluoro-p-tolyl)hydrazone.

For their use according the present invention, the compounds I can be converted into the customary formulations, for example solutions, emulsions, suspensions, dusts, powders, pastes and granules. The application form depends on the particular purpose; in each case, it should ensure a fine and uniform distribution of the compound according to the invention.

The formulations are prepared in a known manner, for example by extending the active compound with solvents and/or carriers, if desired using emulsifiers and dispersants. Solvents/auxiliaries which are suitable include:
water, aromatic solvents (for example Solvesso products, xylene), paraffins (for example mineral fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.
carriers such as ground natural minerals (for example kaolins, clays, talc, chalk) and ground synthetic minerals (for example highly disperse silica, silicates); emulsifiers such as nonionic and anionic emulsifiers (for example polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The following are examples of formulations:

1. Products for Dilution with Water

### A) Soluble Concentrates (SL)

10 parts by weight of the active compounds are dissolved in water or in a water-soluble solvent. As an alternative, wetters or other auxiliaries are added. The active compound dissolves upon dilution with water.

### B) Dispersible Concentrates (DC)

20 parts by weight of the active compounds are dissolved in cyclohexanone with addition of a dispersant, for example polyvinylpyrrolidone. Dilution with water gives a dispersion.

### C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

### D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifier (Ultraturax) and made into a homogeneous emulsion. Dilution with water gives an emulsion.

### E) Suspensions (SC, OD)

In an agitated ball mill, 20 parts by weight of the active compounds are comminuted with addition of dispersant, wetters and water or an organic solvent to give a fine active compound suspension. Dilution with water gives a stable suspension of the active compound.

### F) Water-Dispersible Granules and Water-Soluble Granules (WG, SG)

50 parts by weight of the active compounds are ground finely with addition of dispersants and wetters and made into water-dispersible or water-soluble granules by means of technical appliances (for example extrusion, spray tower, fluidized bed). Dilution with water gives a stable dispersion or solution of the active compound.

### G) Water-Dispersible Powders and Water-Soluble Powders (WP, SP)

75 parts by weight of the active compounds are ground in a rotor-stator mill with addition of dispersant, wetters and silica gel. Dilution with water gives a stable dispersion or solution with the active compound.

### 2. Products to be Applied Undiluted

### H) Dustable Powders (DP)

5 parts by weight of the active compounds are ground finely and mixed intimately with 95% of finely divided kaolin. This gives a dustable product.

### I) Granules (GR, FG, GG, MG)

0.5 part by weight of the active compounds is ground finely and associated with 95.5% carriers. Current methods are extrusion, spray-drying or the fluidized bed. This gives granules to be applied undiluted.

### J) ULV Solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; it is intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Compositions of this invention may also contain other active ingredients, for example other oils, wetters, adjuvants, herbicides, fungicides, insecticides, herbicides, fertilizers such as ammonium nitrate, urea, potash, and superphosphate, phytotoxicants and plant growth regulators, safeners and nematicides. These additional ingredients may be used sequentially or in combination with the above-described compositions, if appropriate also added only immediately prior to use (tank mix). For example, the plant(s) may be sprayed with a composition of this invention either before or after being treated with other active ingredients. These agents can be admixed with the agents according to the invention in a weight ratio of 1:10 to 10:1.

The following list of pesticides together with which the compounds of formula I can be used according to the inventive method, is intended to illustrate the possible combinations, but not to impose any limitation:

A.1. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;

A.2. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;

A.3. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;

A.4. Growth regulators: a) chitin synthesis inhibitors: benzoylureas: chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;

A.5. Nicotinic receptor agonists/antagonists compounds: clothianidin, dinotefuran, imidacloprid, thiamethoxam, nitenpyram, acetamiprid, thiacloprid; the thiazol compound of formula Γ¹

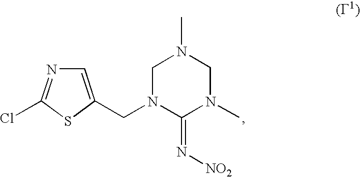

A.6. GABA antagonist compounds: acetoprole, endosulfan, ethiprole, fipronil, vaniliprole, pyrafluprole, pyriprole, the phenylpyrazole compound of formula Γr²

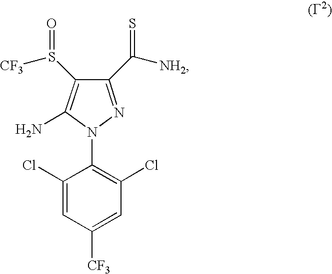

A.7. Macrocyclic lactone insecticides: abamectin, emamectin, milbemectin, lepimectin, spinosad,

A.8. METI I compounds: fenazaquin, pyridaben, tebufenpyrad, tolfenpyrad, flufenerim;

A.9. METI II and III compounds: acequinocyl, fluacyprim, hydramethylnon;

A.10. Uncoupler compounds: chlorfenapyr;

A.11. Oxidative phosphorylation inhibitor compounds: cyhexatin, diafenthiuron, fenbutatin oxide, propargite;

A.12. Moulting disruptor compounds: cyromazine;

A.13. Mixed Function Oxidase inhibitor compounds: piperonyl butoxide;

A.14. Sodium channel blocker compounds: indoxacarb, metaflumizone,

A.15. Various: benclothiaz, bifenazate, cartap, flonicamid, pyridalyl, pymetrozine, sulfur, thiocyclam, flubendiamide, cyenopyrafen, flupyrazofos, cyflumetofen, amidoflumet, the aminoisothiazole compounds of formula Γ³,

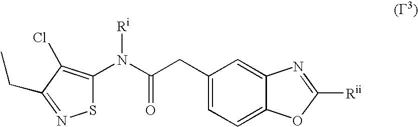

wherein Rⁱ is —CH₂OCH₂CH₃ or H and Rⁱⁱ is CF₂CF₂CF₃ or CH₂CH(CH₃)₃, the anthranilamide compounds of formula Γ4

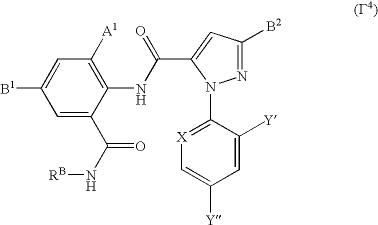

wherein A¹ is CH₃, Cl, Br, I, X is C—H, C—Cl, C—F or N, Y′ is F, Cl, or Br, Y″ is hydrogen, F, Cl, CF₃, B¹ is hydrogen, Cl, Br, I, CN, B² is Cl, Br, CF₃, OCH₂CF₃, OCF₂H, and R^{B} is hydrogen, CH₃ or CH(CH₃)₂, and the malononitrile compounds as described in JP 2002 284608, WO 02/89579, WO 02/90320, WO 02/90321, WO 04/06677, WO 04/20399, JP 2004 99597, WO 05/68423, WO 05/68432, or WO 05/63694, especially the malononitrile compounds CF₂HCF₂CF₂CF₂CH₂C(CN)₂CH₂CH₂CF₃ (2-(2,2,3,3,4,4,5,5-octafluoropentyl)-2-(3,3,3-trifluoropropyl)-malononitrile), CF₃(CH₂)₂C(CN)₂CH₂(CF₂)₅CF₂H (2-(2,2,3,3,4,4,5,5,6,6,7,7-Dodecafluoro-heptyl)-2-(3,3,3-trifluoro-propyl)-malononitrile), CF₃(CH₂)₂C(CN)₂(CH₂)₂C(CF₃)₂F (2-(3,4,4,4-Tetrafluoro-3-trifluoromethyl-butyl)-2-(3,3,3-trifluoro-propyl)-malononitrile), CF₃(CH₂)₂C(CN)₂(CH₂)₂(CF₂)₃CF₃ (2-(3,3,4,4,5,5,6,6,6-Nonafluoro-hexyl)-2-(3,3,3-trifluoro-propyl)-malononitrile), CF₂H(CF₂)₃CH₂C(CN)₂CH₂(CF₂)₃CF₂H (2,2-Bis-(2,2,3,3,4,4,5,5-octafluoro-pentyl)-malononitrile), CF₃(CH₂)₂C(CN)₂CH₂(CF₂)₃CF₃ (2-(2,2,3,3,4,4,5,5,5-Nonafluoro-pentyl)-2-(3,3,3-trifluoro-propyl)-malononitrile), CF₃(CF₂)₂CH₂C(CN)₂CH₂(CF₂)₃CF₂H (2-(2,2,3,3,4,4,4-Heptafluoro-butyl)-2-(2,2,3,3,4,4,5,5-octafluoro-pentyl)-malononitrile) and CF₃CF₂CH₂C(CN)₂CH₂(CF₂)₃CF₂H (2-(2,2,3,3,4,4,5,5-Octafluoro-pentyl)-2-(2,2,3,3,3-pentafluoro-propyl)-malononitrile).

The commercially available compounds of the group A may be found in The Pesticide Manual, 13^{th} Edition, British Crop Protection Council (2003) among other publications. Thiamides of formula Γ² and their preparation have been described in WO 98/28279. Aminoisothiazole compounds of formula Γ³ and their preparation have been described in WO 00/06566. Lepimectin is known from Agro Project, PJB Publications Ltd, November 2004. Benclothiaz and its preparation have been described in EP-A1 454621. Methidathion and Paraoxon and their preparation have been described in Farm Chemicals Handbook, Volume 88, Meister Publishing Company, 2001. Acetoprole and its preparation have been described in WO 98/28277. Metaflumizone and its preparation have been described in EP-A1462 456. Flupyrazofos has been described in Pesticide Science 54, 1988, p. 237-243 and in U.S. Pat. No. 4,822,779. Pyrafluprole and its preparation have been described in JP 2002193709 and in WO 01/00614. Pyriprole and its preparation have been described in WO 98/45274 and in U.S. Pat. No. 6,335,357. Amidoflumet and its preparation have been described in U.S. Pat. No. 6,221,890 and in JP 21010907. Flufenerim and its preparation have been described in WO 03/007717 and in WO 03/007718. Cyflumetofen and its preparation have been described in WO 04/080180.

Anthranilamides of formula Γ⁴ and their preparation have been described in WO 01/70671; WO 02/48137; WO 03/24222, WO 03/15518, WO 04/67528; WO 04/33468; and WO 05/118552. The malononitrile compounds CF₂HCF₂CF₂CF₂CH₂C(CN)₂CH₂CH₂CF₃ (2-(2,2,3,3,4,4,5,5-octafluoropentyl)-2-(3,3,3-trifluoropropyl)-malononitrile), CF₃(CH₂)₂C(CN)₂CH₂(CF₂)₅CF₂H (2-(2,2,3,3,4,4,5,5,6,6,7,7-Dodecafluoro-heptyl)-2-(3,3,3-trifluoro-propyl)-malononitrile), CF₃(CH₂)₂C(CN)₂(CH₂)₂C(CF₃)₂F (2-(3,4,4,4-Tetrafluoro-3-trifluoromethyl-butyl)-2-(3,3,3-trifluoro-propyl)-malononitrile), CF₃(CH₂)₂C(CN)₂(CH₂)₂(CF₂)₃CF₃ (2-(3,3,4,4,5,5,6,6,6-Nonafluoro-hexyl)-2-(3,3,3-trifluoro-propyl)-malononitrile), CF₂H(CF₂)₃CH₂C(CN)₂CH₂(CF₂)₃CF₂H (2,2-Bis-(2,2,3,3,4,4,5,5-octafluoro-pentyl)-malononitrile), CF₃(CH₂)₂C(CN)₂CH₂(CF₂)₃CF₃ (2-(2,2,3,3,4,4,5,5,5-Nonafluoro-pentyl)-2-(3,3,3-trifluoro-propyl)-malononitrile), CF₃(CF₂)₂CH₂C(CN)₂CH₂(CF₂)₃CF₂H (2-(2,2,3,3,4,4,4-Heptafluoro-butyl)-2-(2,2,3,3,4,4,5,5-octafluoro-pentyl)-malononitrile) and CF₃CF₂CH₂C(CN)₂CH₂(CF₂)₃CF₂H (2-(2,2,3,3,4,4,5,5-Octafluoro-pentyl)-2-(2,2,3,3,3-pentafluoro-propyl)-malononitrile) have been described in WO 05/63694.

The bugs may be controlled by contacting the bug, its food supply, habitat, breeding ground or its locus with a pesticidally effective amount of compounds of or compositions of formula I.

“Locus” means a habitat, breeding ground, plant, seed, soil, area, material or environment in which a bug is growing or may grow.

The bugs may also be controlled by contacting the plant—typically to the foliage, stem or roots of the—with a pesticidally effective amount of compounds of formula I.

In general, “pesticidally effective amount” means the amount of active ingredient needed to achieve an observable effect on growth, including the effects of necrosis, death, retardation, prevention, and removal, destruction, or otherwise diminishing the occurrence and activity of the bug. The pesticidally effective amount can vary for the various compounds/compositions used in the invention. A pesticidally effective amount of the compositions will also vary according to the prevailing conditions such as desired pesticidal effect and duration, weather, target species, locus, mode of application, and the like.

Thus, the compounds of formula I are effective against plant bugs through both contact (via soil or plant parts), and ingestion (plant part).

The present invention favourably pertains to a method of combating bugs by
a) monitoring the bugs and
b) contacting the bugs or their food supply, habitat, breeding grounds or their locus with a pesticidally effective amount of a compound of formula I

Monitoring is done in order to detect the presence and/or number of bugs, i.e. whether the number of bugs exceeds a certain threshold. The threshold will vary depending on the specific circumstances such as the bug species, the fruit, vegetable, or other plant. Generally, control of the bugs with insecticides is recommended when the number of bugs escapes from the control provided by natural enemies. It goes without saying that in some crops, bug control with insecticides favorably is done when the number of bugs is even lower to reduce the damage to a minimum.

Bug monitoring methods are known to the artisan. Established methods include, but are not limited to, tree examinations, jarring or beating tray counts, sweep sampling, damage counts, and cutting out soil. Obviously, also any other method that gives information about the presence and/or the number of bugs in a crop can be applied.

Beat tray sampling is done with a framed sheet placed on the ground beneath the tree, or with a hand held square yard canvas beating tray. One or two branches are beated with a stick or shaken abruptly. Insects that land on the cloth are counted immediately.

Sweep sampling is done, for example, in orchards or rice fields. In rice, sampling is done at several locations per field when the rice plants begin heading. The open mouth of the net makes contact with the heads of the rice plants in order to capture the bugs. Rice field scouting is favorable done once a week until rice heads are mature. Sweep sampling is also targeted for all bugs present in the ground cover.

Damage counts are e.g. done for fruits or rice. Bug-specific damage indicates the presence of bugs.

Cutting out soil is e.g. done by inserting a metal can into the soil around the plants, filling the can with water and waiting for a few minutes for the bugs to float the surface.

For use in treating crop plants, the rate of application of the compounds of formula I may be in the range of 0.1 g to 4000 g per hectare, desirably from 25 g to 600 g per hectare, more desirably from 50 g to 500 g per hectare.

In the case of soil treatment, the quantity of active ingredient ranges from 0.0001 to 500 g per 100 m², preferably from 0.001 to 20 g per 100 m².

### Activity Against Bugs

### Test Methodology

Host plants (such as rice, wheat, and cabbage) were treated with 50, 150 or 300 ppm of a compound of formula I. Treatments were diluted in water and applied at 400 to 600 liters/hectare to experimental plots using standard application equipment (such as a backpack sprayer). Each treatment was replicated 3 times and comprised an area of approximately 30 square meters. Pre-treatment evaluations of the number of live insects per plant were made one day prior to first treatment. Post-treatment evaluations were made at 5 to 7 day intervals. Field studies were conducted under ambient conditions during normal growing season.

In these tests, N-ethyl-2,2-dichloro-1-methylcyclopropane-carboxamide, 2-(2,6-dichloro-α,α,α-trifluoro-p-tolyl)hydrazone exhibited over 75% control at the following rates:

| | | | Rate |
|---|---|---|---|
| Crop | Bug [latin name] | Bug [English name] | [ppm] |
| Rice | Trigonotylus coelestialum | Rice leaf bug | 50 |
| Rice | Stenotus rubrovittatus | Sorghum plant bug | 50 |
| Rice | Paromius exiguus | — | 300 |
| Rice | Nezara antennata | Common green stink | 300 |
| | | bug | |
| Alfalfa | Lygus hesperus | Western plant bug | 100 |
| Rice | Leptocorisa corbetti | Leaf-footed bug | 50 |
| Rice | Lagynotomus elongatus | Brown rice stink bug | 150 |
| Alfalfa | Halticus bracteatus | Garden fleahopper | 300 |
| Rice | Euschistus spp | Stink bug spp. | 300 |
| Cabbage | Eurydema ornatum | Cabbage bug | 50 |
| Rice | Cletus trigonus | Slender rice bug | 50 |

1-7. (canceled)

8. A method of combating bugs comprising:
contacting bugs or their food supply, habitat, breeding grounds or their locus with a pesticidally effective amount of a compound of formula I: 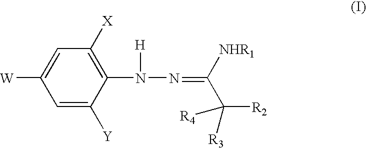
wherein
W is chlorine or trifluoromethyl;
X and Y are each independently chlorine or bromine;
R¹ is C₁-C₆-alkyl, C₃-C₆-alkenyl, C₃-C₆-alkynyl, or
C₃-C₆-cycloalkyl which may be substituted with 1 to 3 halogen atoms, or
C₂-C₄-alkyl which is substituted by C₁-C₄-alkoxy;
R² and R³ are C₁-C₆-alkyl or may be taken together to form C₃-C₆-cycloalkyl which may be unsubstituted or substituted by 1 to 3 halogen atoms;
R⁴ is hydrogen or C₁-C₆-alkyl,
or enantiomers or salts thereof; wherein the bugs are selected from the families of Coreidae, Lygaeidae, Miridae, Nabidae, Pentatomidae, Pyrrhocoridae, Rhopalidae, Scutelleridae, and Tingidae;
wherein the bugs are combated.

9. The method of claim 8, wherein a bug monitoring step precedes the contacting step.

10. The method of claim 8, wherein the bugs are stink bugs.

11. The method of claim 8, wherein the compound of formula I is applied in an amount of from 5 g/ha to 2000 g/ha.

12. The method of claim 8, wherein the compound of formula I is N-ethyl-2,2-dimethylpropionamide-2-(2,6-dichloro-α-α-α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.

13. The method of claim 11, wherein a bug monitoring step precedes the contacting step.

14. The method of claim 8, wherein the bugs are combated in or on a crop selected from the group consisting of: broad-leaf weeds, soybean, snap bean, maize, sorghum, sunflower, cotton, colza, cereals like barley, oats, rye, wheat, rice, corn, vegetables, snap beans, pole beans, Lima beans, cabbage, cantaloupe, cucumber, leafy greens, okra, onions, pepper, peas, squash, sweet corn, potato, eggplant, tomato, lettuce, leek, garlic, onion, carrot, sugar beet, (water)melon, cauliflower, broccoli, pumpkin, gourds, turnip, radish, fruits selected from the group consisting of: lemon, mandarin, orange, stone fruits, mulberries, grape, apricot, cherry, peach, pear, pome fruit, fig, kurrajong, and strawberry; and ornamental plants selected from the group consisting of wisteria, dahlia, violet, geranium, and petunia.

15. The method of claim 14, wherein the compound of formula I is N-ethyl-2,2-dimethylpropionamide-2-(2,6-dichloro-α-α-α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.

16. The method of claim 11, wherein the bugs are combated in or on a crop selected from the group consisting of: broad-leaf weeds, soybean, snap bean, maize, sorghum, sunflower, cotton, colza, cereals like barley, oats, rye, wheat, rice, corn, vegetables, snap beans, pole beans, Lima beans, cabbage, cantaloupe, cucumber, leafy greens, okra, onions, pepper, peas, squash, sweet corn, potato, eggplant, tomato, lettuce, leek, garlic, onion, carrot, sugar beet, (water)melon, cauliflower, broccoli, pumpkin, gourds, turnip, radish, fruits selected from the group consisting of: lemon, mandarin, orange, stone fruits, mulberries, grape, apricot, cherry, peach, pear, pome fruit, fig, kurrajong, and strawberry; and ornamental plants selected from the group consisting of wisteria, dahlia, violet, geranium, and petunia.

17. The method of claim 16, wherein the compound of formula I is N-ethyl-2,2-dimethylpropionamide-2-(2,6-dichloro-α-α-α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.

18. A method for protecting growing plants from attack or infestation by bugs comprising:
contacting a plant, or soil or water in which the plant is growing, with a pesticidally effective amount of compositions or compounds of formula I: 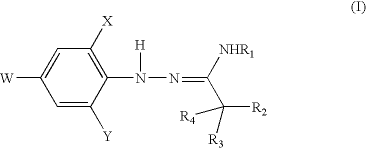
wherein
W is chlorine or trifluoromethyl;
X and Y are each independently chlorine or bromine;
R¹ is C₁-C₆-alkyl, C₃-C₆-alkenyl, C₃-C₆-alkynyl, or
C₃-C₆-cycloalkyl which may be substituted with 1 to 3 halogen atoms, or
C₂-C₄-alkyl which is substituted by C₁-C₄-alkoxy;
R² and R³ are C₁-C₆-alkyl or may be taken together to form C₃-C₆-cycloalkyl which may be unsubstituted or substituted by 1 to 3 halogen atoms;
R⁴ is hydrogen or C₁-C₆-alkyl,
or enantiomers or salts thereof; wherein the bugs are selected from the families of Coreidae, Lygaeidae, Miridae, Nabidae, Pentatomidae, Pyrrhocoridae, Rhopalidae, Scutelleridae, and Tingidae;
wherein the growing plants are protected from attack or infestation by bugs.

19. The method of claim 18, wherein a bug monitoring step precedes the contacting step.

20. The method of claim 18, wherein the bugs are stink bugs.

21. The method of claim 18, wherein the compound of formula I is applied in an amount of from 5 g/ha to 2000 g/ha.

22. The method of claim 18, wherein the compound of formula I is N-ethyl-2,2-dimethylpropionamide-2-(2,6-dichloro-α-α-α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.

23. The method of claim 21, wherein a bug monitoring step precedes the contacting step.

24. The method of claim 18, wherein the growing plant is selected from the group consisting of: broad-leaf weeds, soybean, snap bean, maize, sorghum, sunflower, cotton, colza, cereals like barley, oats, rye, wheat, rice, corn, vegetables, snap beans, pole beans, Lima beans, cabbage, cantaloupe, cucumber, leafy greens, okra, onions, pepper, peas, squash, sweet corn, potato, eggplant, tomato, lettuce, leek, garlic, onion, carrot, sugar beet, (water)melon, cauliflower, broccoli, pumpkin, gourds, turnip, radish, fruits selected from the group consisting of: lemon, mandarin, orange, stone fruits, mulberries, grape, apricot, cherry, peach, pear, pome fruit, fig, kurrajong, and strawberry; and ornamental plants selected from the group consisting of wisteria, dahlia, violet, geranium, and petunia.

25. The method of claim 21, wherein the compound of formula I is N-ethyl-2,2-dimethylpropionamide-2-(2,6-dichloro-α-α-α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.

26. The method of claim 21 wherein the growing plant is selected from the group consisting of: broad-leaf weeds, soybean, snap bean, maize, sorghum, sunflower, cotton, colza, cereals like barley, oats, rye, wheat, rice, corn, vegetables, snap beans, pole beans, Lima beans, cabbage, cantaloupe, cucumber, leafy greens, okra, onions, pepper, peas, squash, sweet corn, potato, eggplant, tomato, lettuce, leek, garlic, onion, carrot, sugar beet, (water)melon, cauliflower, broccoli, pumpkin, gourds, turnip, radish, fruits selected from the group consisting of: lemon, mandarin, orange, stone fruits, mulberries, grape, apricot, cherry, peach, pear, pome fruit, fig, kurrajong, and strawberry; and ornamental plants selected from the group consisting of wisteria, dahlia, violet, geranium, and petunia.

27. The method of claim 26, wherein the compound of formula I is N-ethyl-2,2-dimethylpropionamide-2-(2,6-dichloro-α-α-α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.
